(19) United States
(12) Patent Application Publication
(10) Pub. No.: US 2002/0077266 A1
(43) Pub. Date: Jun. 20, 2002

(54) Portable stain removal product

(76) Inventors: Flor Gutierrez Gabriel, Higashinada-ku (JP); Koichi Hirai, Higashinada-ku (JP); Kimiko Mitsunaka, Hyogo (JP); Kenji Shindo, Higashinada-ku (JP)

Correspondence Address: THE PROCTER & GAMBLE COMPANY, PATENT DIVISION, IVORYDALE TECHNICAL CENTER - BOX 474, 5299 SPRING GROVE AVENUE, CINCINNATI, OH, 45217, US

(21) Appl. No.: 09/923,010

(22) Filed: Aug. 3, 2001

(30) Foreign Application Priority Data
Apr. 8, 2000 (US) PCT/US00/21382

(51) Int. Cl. C11D 17/00

(52) U.S. Cl. 510/297; 510/300

(57) ABSTRACT

Stain removal patch having a substrate and a first stain receiver. The first stain receiver has a liquid cleaner absorbed therein, and is adjacent the first surface of the substrate. At least a portion of the substrate extends beyond the perimeter of the stain receiver. There is an adhesive agent between the substrate and the stain receiver and at least a portion at the adhesive agent on the substrate extends beyond the perimeter of the stain receiver.

### FIELD OF THE INVENTION

The present invention relates to a stain removal product. Specifically, the present invention relates to a stain removal product for small, localized stains. More specifically, the present invention relates to a portable spot stain removal product in the form of an adhesive patch.

### BACKGROUND

Consumers are sensitive about stains on fabrics such as clothing, and they are especially concerned about removing stains. Usually they wash their clothes at home to remove stains. In some cases, however, they cannot wait to wash their clothes until returning home. For example, some food might be spilled on their clothes when they are away from home. In these cases, quick stain removal is essential because stains become deeply ingrained in fabrics as time goes by and they becomes more difficult to remove.

Some stains are relatively easy to remove. For example, water soluble stains can often be removed with wet-tissue paper and some pressure applied to the stains. However, many stains such as food stains or soil stains are difficult to remove using such a method. Brushing is another way for removing soils. But brushing may cause some damage to the fabrics. In short, shearing stress by a brush may tear or degrade fabrics. As a result, clothes look worn, which is unfavorable for consumers.

There are some liquid spot stain removal products in the market. However, such products were developed for home-use and are generally not portable. For example, consumers may need to wet and rinse the fabrics when using these products. To solve these problems, pen-type or tissue type stain removal products were developed. These products apply stain removal solutions to the fabric. But if the consumer is still wearing the fabrics, the stain removal solution can pass through the fabric to the consumer's skin. Stain removal solutions are often not intended for direct application to the skin. And these products may cause “ring” stains after use which are formed by residual cleaning solution that has not been rinsed away.

Based on the foregoing, there is a need for a new stain removal products which are easy to carry, do not to spill or leak when carried, are safe on fabrics and provide sufficient performance for stain removal from fabrics.

### SUMMARY

The present invention is directed to a portable stain removal patch which contains a substrate, a first stain receiver and an adhesive agent. The substrate has a first and second surface. The first stain receiver has a first and second surface and an edge that defines a first stain receiver perimeter. The first stain receiver comprises a liquid cleaner absorbed therein. The second surface of the first stain receiver is adjacent to the first surface of the substrate. At least a portion of the first surface of the substrate extends beyond the perimeter of the first stain receiver. An adhesive agent is between the first surface of the substrate and the second surface of the first stain receiver and at least a portion of the adhesive agent on the first surface of the substrate extends beyond the perimeter of the first stain receiver.

The stain removal products of the present invention can be used to remove stains on clothes, shoes, carpets, car seats as well as hard surfaces.

These and other features, aspects, and advantages of the present invention will become evident to those skilled in the art from a reading of the present disclosure with the appended claims.

### BRIEF DESCRIPTION OF THE DRAWINGS

While the specification concludes with claims which particularly point out and distinctly claim the invention, it is believed the present invention will be better understood from the following description of preferred embodiments taken in conjunction, in which like reference numerals identify identical elements and wherein:

FIG. 1 is a schematic perspective view of one embodiment of a stain removal patch of the present invention.

FIG. 2 is a schematic perspective view of one embodiment of a stain removal patch of the present invention, wherein the substrate extends from only two sides of the stain removal patch.

FIG. 3 is a schematic perspective view of one embodiment of a stain removal patch of the present invention having a circular shaped first stain receiver.

FIG. 4 of is a schematic perspective view of one embodiment of a stain removal patch of the present invention, wherein the first stain receiver has a liquid permeable barrier and a window.

FIG. 5 is a cross-sectional view of the stain removal patch in FIG. 4.

FIG. 6 is a schematic perspective view of one embodiment of a stain removal patch of the present invention having a first stain receiver and a second stain receiver.

FIG. 7 is a schematic perspective view of one embodiment of a stain removal patch of the present invention having a first stain receiver and a second stain receiver, wherein the second stain receiver is adjacent the perimeter of the first stain receiver.

FIG. 8 is a schematic perspective view of one embodiment of a stain removal patch of the present invention having a first stain receiver and a second stain receiver, wherein the second stain receiver has a liquid permeable barrier.

FIG. 9 is a cross-sectional view of the stain removal patch in FIG. 9.

FIG. 10 is a schematic perspective view of one embodiment of a stain removal patch of the present invention having a cover sheet.

### DETAILED DESCRIPTION

The following is a list of definitions for terms used herein.

“Comprising” means that other steps and other ingredients which do not affect the end result can be added. This term encompasses the terms “consisting of” and “consisting essentially of”.

All percentages are by weight of total composition unless specifically stated otherwise.

All cited references are incorporated herein by reference in their entireties. Citation of any reference is not an admission regarding any determination as to its availability as prior art to the claimed invention.

All ratios are weight ratios unless specifically stated otherwise.

The present invention, in its product aspects, is described in detail as follows.

The Stain Removal Patch of the Present Invention

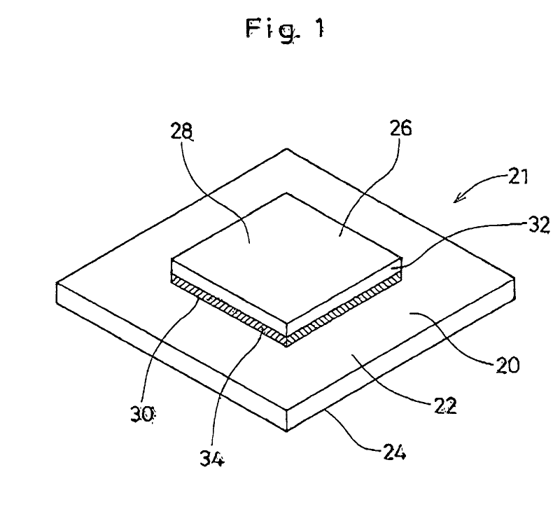

The stain removal patch of the present invention contains a substrate, a first stain removal patch and an adhesive agent. FIG. 1 is a schematic representation of one embodiment of a stain removal patch of the present invention. The stain removal patch 21 has a substrate 20, a first stain receiver 26 and an adhesive agent 34. Substrate 20 has a first surface 22 and second surface 24. First stain receiver 26 has a first surface 28, a second surface 30 and a first stain receiver edge 32. Second surface 24 of first stain receiver 26 is adjacent to first surface 22 of substrate 20. At least, a portion of the first surface of substrate 22 extends beyond the perimeter of first stain receiver 26. The perimeter of first stain receiver 26 is defined by first stain receiver edge 32. There is an adhesive agent 34 between first surface 22 of substrate 20 and second surface 30 of first stain receiver 26 is and at least a portion at adhesive agent 34 on first surface 22 of substrate 20 extends beyond the perimeter of first stain receiver 26.

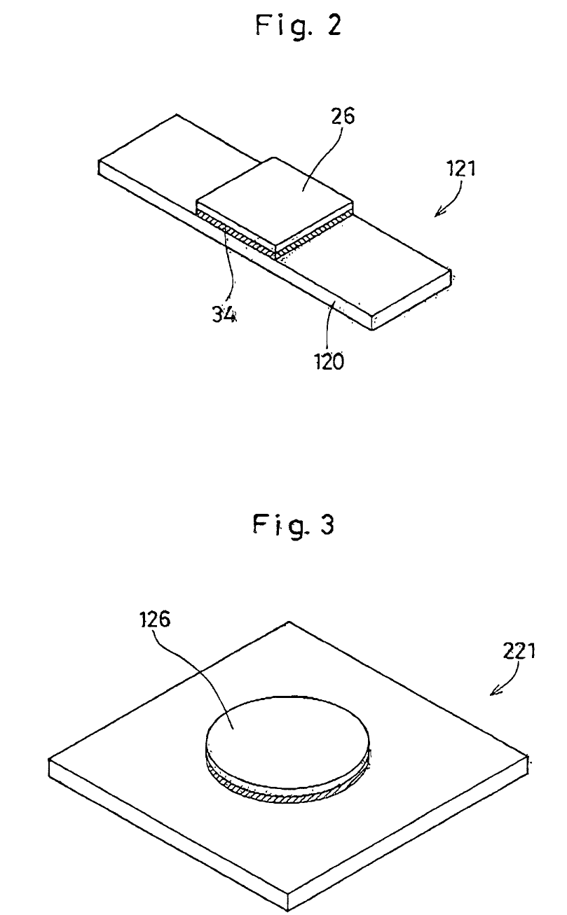

The portion of substrate 20 of stain removal patch 121 that extends beyond the perimeter of first stain receiver 26 can extend in any direction away from the perimeter of first stain receiver 26. FIG. 2 is a schematic perspective view of another embodiment of a stain removal patch of the present invention having the substrate which extends from only two sides of first stain receiver 26. The stain removal patch 121 has a substrate 120, a first stain receiver 26 and an adhesive agent 34.

Water proof materials are preferably used for the substrate of the present invention in order to prevent liquid cleaners from leaking onto areas other than where the stain is located. More preferably, the materials are selected from the group consisting of polypropylene, polyethylene, polyethylene terephthalate (PET), rubbers and a mixture thereof. Mixtures of these materials would include multi-layer laminations of these materials.

The thickness of the substrate is preferably from about 0.001 mm to about 1 mm, more preferably from about 0.05 mm to 0.1 mm of thickness.

The first surface of the substrate can also be partially or fully coated with an adhesive agent. The adhesive agent contacts the surface that is stained. Thus, the adhesive agent needs to be selected in view of maintaining the care of the surface material. If the adhesive is too strong, the surface material may be damaged. Conversely, the adhesive agent needs to have sufficient strength to stick to the surface material. Considering this, the adhesive agents which are used for adhesive patch or pap type products are preferable adhesive agents in the present invention. Such adhesive agents are selected from the group consisting of natural adhesives (e.g., starches, natural rubbers), thermoplastic resins (e.g., vinyl acetates, polyacrylates, polyethylenes, celluloses, polyurethane), thermosetting resins (e.g., ureas, polyesters, polyphenols), elastomers (e.g., silicones, styrene butadiene rubbers (SBR)) or polyurethen. Suitable adhesive agents are disclosed in U.S. Pat. No. 3,865,775, No. 3,865,765 and No. 3,865,764 issued Feb. 11, 1975 to Drelich et al, and in U.S. Pat. No. 4,549,653 issued Sep. 6, 1983 to Nels et al. The entire disclosure of these references are incorporated herein by reference.

Also, the adhesive agent preferably has a strength of more than 50 gf/25 mm on steel, more preferably, from about 100 gf/25 mm to about 500 OOgf/25 mm on steel. This strength is measured by peeling a 25 mm wide adhesive off of a steel surface as defined in Japanese Industrial Standard (JIS) test method (JIS Z 0237:1991) described in JIS handbook, Secchaku, 1992, published by Nihon Kikaku Kyokai.

The first stain receiver contains a liquid cleaner, which is absorbed therein. It is, however, possible for the liquid cleaner to be provided separately form the stain removal patch. Necessarily, before the consumer uses this product, they would add the liquid cleaner to the first stain receiver. In order to retain a sufficient amount of liquid cleaner in the stain receiver, the first stain receiver needs to be made of absorbent material. Preferably the material of the first stain receiver is selected from the group consisting of a polymerizing high internal phase (poly-HIPE) water-in-oil emulsion, a non-woven fiber, a woven fiber, an absorbent paper product and mixtures thereof. More preferably, the stain remover is made of poly-HIPE water-in-oil emulsion, which is sometimes referred to in technical literature as a Functional Absorbent Material (FAM). Preferable FAM has an absorbent ability of more than about 20 g H2O/g, more preferably, 40 g H2O/g by weight of FAM. Such preferable FAM is described in U.S. Pat. No. 5,260,345 to Thomas A. DesMarais, et al., issued on Nov. 9, 1993 or U.S. Pat. No. 5,889,893 to John Collins Dyer, et al., issued on May 4, 1999. The entire disclosure of these references are incorporated herein by reference.

Another preferred material for the first stain receiver is a polyurethane foam. Polyurethane foam is the reaction product of at least one polyol and at least one polyisocyanate in the presence of at least one blowing agent. Suitable polyisocyanates include aromatic polyisocyanates and homologues or higher polymeric adducts thereof, aliphatic and cycloaliphatic polyisocianates, and combination thereof. As used herein, the term “homologues” of aromatic polyisocyanates means those containing 2 or 3 aromatic rings and the term “higher” polyisocyanates means those containing at least 4 aromatic rings. A highly prefered polyisocyanate is a diisocyanate, such as m-phenylene diisocyanate; 2,4-toluene diisocyanate; 2,6-toluen diisocyanate; mixtures of 2,4-toluen diisocyanate and 2,6-toluen diisocyanate; hexamethylene diisocyanate; tetramethylene diisocyanate; 1,4-cyclohexane diisocyanate; hexahydrotoluene diisocyanate; 1,5-naphthalene diisocyanate; 1-methoxy-2,4-phenylene diisocyanate; 2,4′-diphenylmethane diisocyanate; 4,4′-diphenylmethane diisocyanate; 4,4′-biphenylene diisocyanate; 3,3′-dimethoxy-4,4′-biphenyl diisocyanate; 3,3′-dimethyl-4,4′-biphenyl diisocyanate; 3,3′-dimethyl-4,4′-diphenylmethane diisocyanate; 3-isocyanate methyl 3,5,5-trimethylhexylisocyanate; xylene diisocyanate; dicyclohexylmethane diisocyanate and a mixture thereof. Another suitable polyisocyanate is triphenylmethane triisocyanate.

The polyisocyanate is present in such as quantity to provide a ratio of isocyanate groups to each active hydrogen atom present of from about 0.7:1 to about 2.0:1, preferably, from about 0.8:1 to about 1.5:1, and more preferably from about 0.85:1 to about 1.3:1. As used herein, the term “active” hydrogen atom includes the active hydrogen atoms of the polyol and any other compounds present, such as for example water.

Preferably, the polyol herein has a molar average of from about 2 to about 8, preferably from about 2 to about 6, and more preferably from about 2 to about 4 active hydrogen atoms per molecule. Suitable polyols include alkylene glycols, such as ethylene glycol and propylene glycol, glycerin, trimethylolpropane, pentaerythritol, sorbitol, sucrose, bis-2,2-(4-hydroxyphenyl) propane, m-phthalic acid, p-phthalic acid, m orp-phthalic acid dimethylester, m or p-phthalic acid diethylester, castor oil, or polyetherpolyols. Also useful herein are polyether polyols prepared by polymerizing an alkylene oxide such as, for example, ethylene oxide; 1,2-propylene oxide; 1,2- or 2,3-butylene oxide or a mixture thereof, with an initiator containing from about 2 to about 8 active hydrogen atoms, preferably from about 2 to about 6 active hydrogen atoms, and more preferably from about 2 to about 4 active hydrogen atoms per molecule, in the presence of an alkoxylation catalyst.

The weight ratio of total isocyanate to total polyol is from about 1:1 to about 1:10, and preferably from about 1:1 to about 1:2.

Examples of a preferable polyurethane useful herein are described in U.S. Pat. No. 5,089,534 to Thoen, et al., issued on Feb. 18, 1992, U.S. Pat. No. 4,789,690 to Milovanovic-Lerik, et al., issued on Dec. 6, 1988, Japanese Patent Publication No. 10-182780 A to Kao, published on Jul. 7, 1998, Japanese Patent Publication No. 9-30215 to Yokohama Gum, published on Feb. 4, 1997, Japanese Patent Publication No. 5-70544 A to The Dow Chemical Company, published on Mar. 23, 1993, or Japanese Patent Publication No. 10-176073 A to The Bridgestone Company, published on Jun. 30, 1998.

A blowing agent is a preferred ingredient to produce polyurethane forms. During polyurethane synthesis via polymerization of polyols and polyisocyanates, a blowing agent liberates gas in the polyurethane and creates porosity inside the polyurethane to form a polyurethane form. The blowing agent useful herein is selected from the group consisting of water, carbon dioxide, sodium carbonate, sodium bicarbonate, ammonium carbonate, trichlorofluoromethane, dichlorodifluoromethane, dichloromonofluoroethane, pentafluoropropane, tetrafluoroethane and a mixture thereof.

Optionally, catalysts can be useful to accelerate polymerization reaction of polyurethane from one polyol and at least one polyisocyanate. Suitable catalysts are amines, metal catalysts and silicone oils. Suitable amines are selected from the group consisting of primary, secondary, tertiary or quaternary amine and a mixture thereof. Preferred amine is tertiary amine. Examples of the tertiary amines are trimethylamine, triethylamine, dimethylaminoethylether, 2-dimethyltriethylenediamine, triethylenediamine, diethanolamine, tetramethylethylenediamine, tetramethylhexamethylenediamine, dimethylcyclohexylamine, tetramethylpropylenediamine, trimethylaminoethylethanolamine, dimethylethylethanolamine, dimethylaminoethoxylethanol, dimethylaminohexanol, trio-(dimethylaminopropyl)hexahydro-ρ-triamine, dimethylbenzylamine, dimethylaminomorpholine, methylmorpholline, ethylmorpholine, trimethylaminoethylpiperidine, methylhydroxylpiperidine, 1-isobutyl-2-methylimidazole and a mixture thereof. Metal catalysts can be used. Suitable metal catalysts are organic metal catalysts such as dibutyltin(IV)dilaurate, Lead(ii) 2-ethylhexylate, Potassium ethylhexylate, Potassium acetate.

In general, a polyurethane foam is categorized into one of two groups, based on the hardness of the polyurethane foam, i.e., soft or hard polyurethane foam. In the present invention, there is no limitation on the hardness of the polyurethane foam useful herein; both soft and hard polyurethane forms are applicable in the present invention.

When the first stain receiver is applied to the stained surface, the liquid cleaner penetrates the stained surface and solublize the stains. The fist stain receiver re-absorbs the stain with the liquid cleaner.

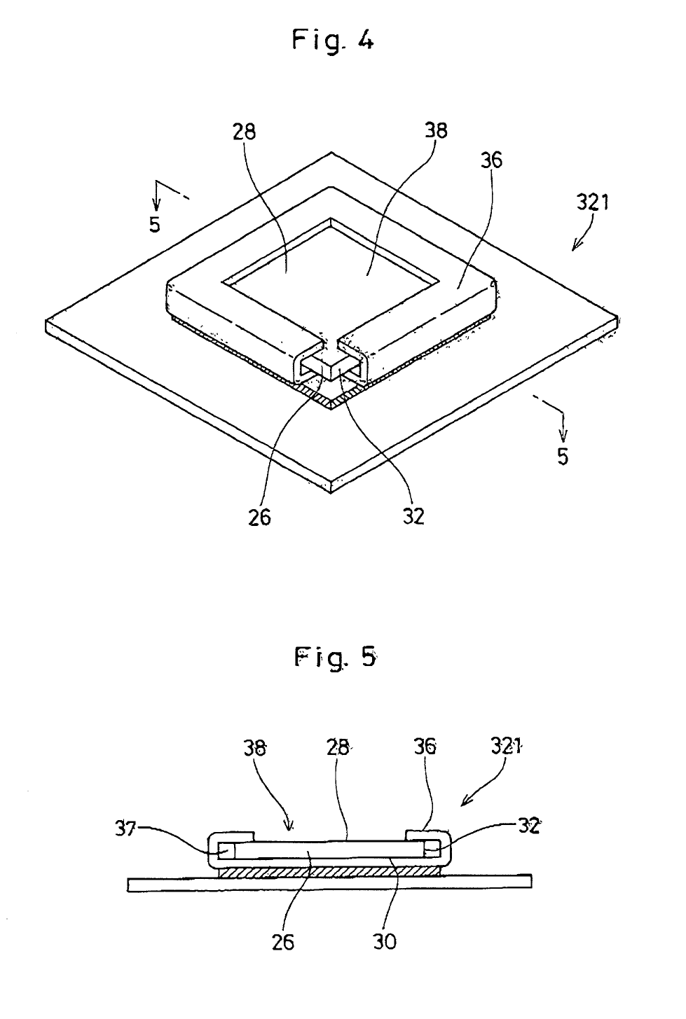

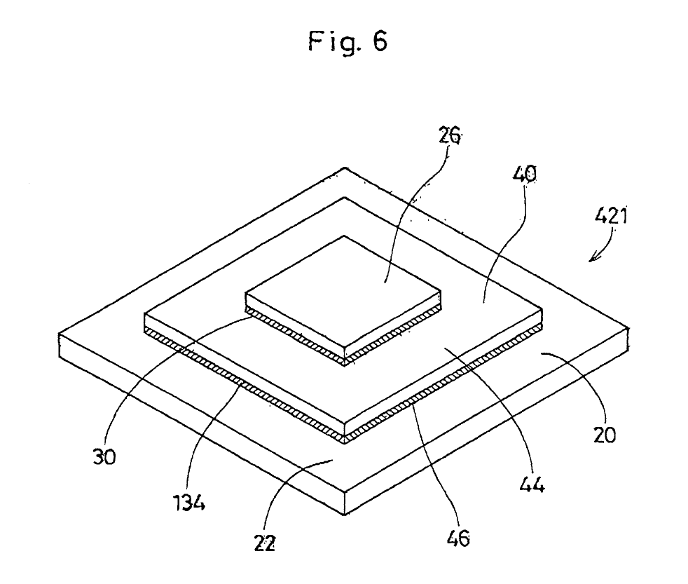

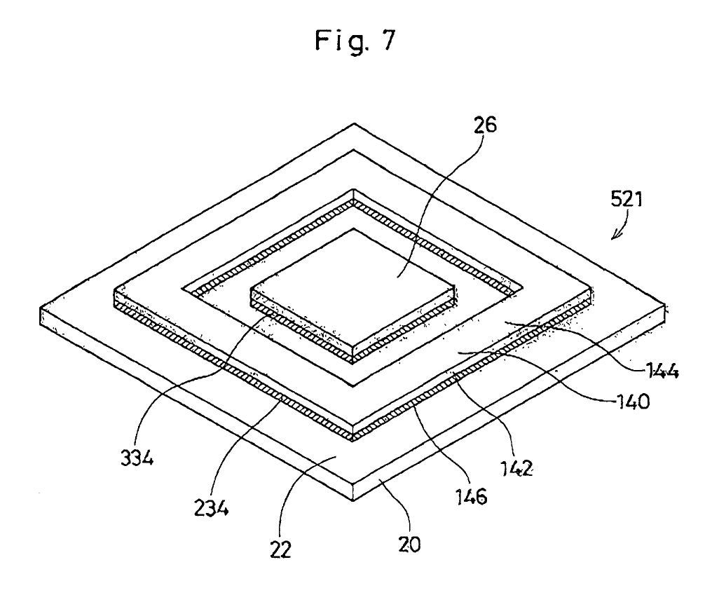

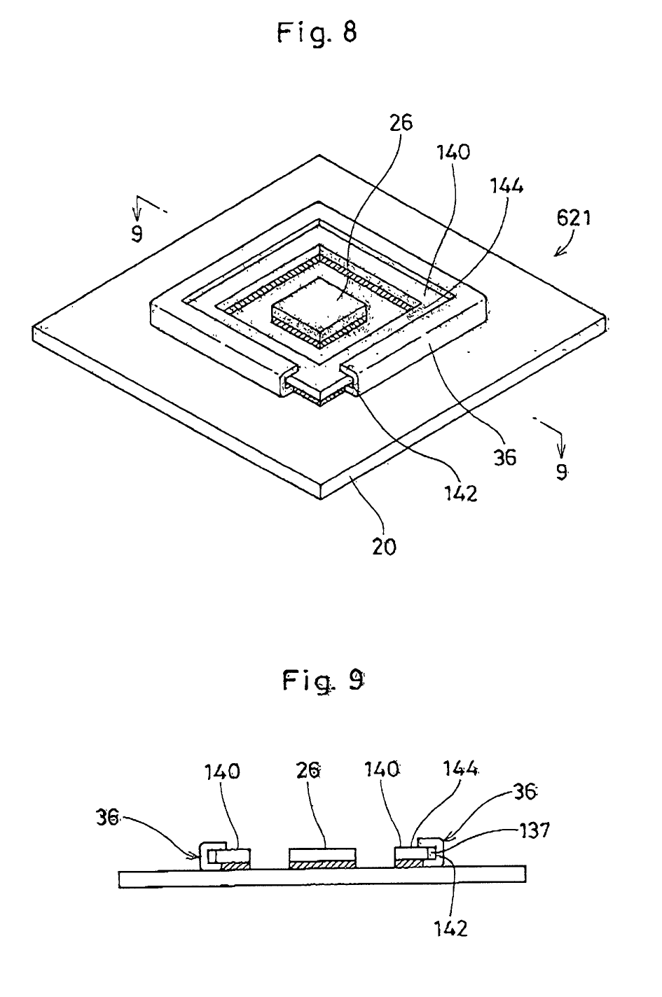

The first stain receiver can be made in any size and shape. FIG. 3 is a schematic perspective view of another embodiment of a stain removal patch of the present invention. The stain removal patch 221 of the present invention has a circular shaped first stain receiver 126.

FIG. 4 shows another embodiment of this invention, wherein the first stain receiver has a liquid impermeable barrier 36 which defines a window 38. The stain removal patch 321 has a first stain receiver 26 having a liquid impermeable barrier 36. As FIG. 4 shows, the liquid impermeable barrier 36 covers first stain receiver edge 32 and extends over first stain receiver edge 32 to cover at least a portion of first surface 28 of first stain receiver 26 forming window 38. Window 38 exposes a portion of first surface 28 of first stain receiver 26. Preferably, the area of the window 38 is from about 50% to about 99.9%, more preferably, from about 65% to about 99.9% of the surface area of the first stain receiver. In use, pressure is applied to the first stain receiver to force the liquid cleaner onto the stained surface. The liquid permeable barrier can help to avoid leakage of the liquid cleaner on to adjacent surfaces those are not stained. The liquid cleaner is re-absorbed in the first stain receiver after the pressure is withdrawn.

Also, even before using, some pressure may be inadequately applied to the first stain receiver while carrying the stain removal patch product. The liquid permeable barrier may help prevent the liquid cleaner from leaking out of the first stain receiver.

FIG. 5 shows a cross-sectional view of the stain removal patch in FIG. 4 as viewed along line 5-5. First stain receiver 26 is wrapped by liquid permeable barrier 36 from second surface 30 to first surface 28 and window 38 is formed. Space 37 is formed between first stain receiver edge 32 and liquid permeable barrier 36. Excess liquid cleaner is retained in space 37.

Turning now to FIG. 6 which is a schematic perspective view of another embodiment of a stain removal patch of the present invention. The stain removal patch 421 has a substrate 20, a first stain receiver 26 and a second stain receiver 40. The second stain receiver 40 has a first surface 44, a second surface 46 and a second stain receiver edge 42 which defines a second stain receiver perimeter. Second stain receiver 40 is sandwiched between first stain receiver 26 and substrate 20. Second surface 46 of second stain receiver 40 is adjacent to first surface 22 of substrate 20. Second surface 30 of first stain receiver 26 is adjacent to first surface 44 of second stain receiver 40. At least, a portion of first surface 22 of substrate 20 extends beyond the perimeter of second stain receiver 40 and second stain receiver 40 extends beyond the perimeter of first stain receiver 26. An adhesive agent is placed between first surface 22 of substrate 20 and second surface 46 of second stain receiver 40. At least a portion of adhesive agent 134 on first surface 22 of substrate 20 extends beyond the perimeter of second stain receiver 40. Also, an adhesive agent 234 is placed between first surface 44 of second stain receiver 40 and second surface 30 of first stain receiver 26.

FIG. 7 is a schematic perspective view of another embodiment of a stain removal patch of the present invention having a first stain receiver 26 and a second stain receiver 140. In FIG. 7, the stain removal patch 521 has second stain receiver 140, which is adjacent the perimeter of first stain receiver 26. Second stain receiver 140 has a first surface 144, a second surface 146 and a second stain receiver edge 142. The second surface 30 of first stain receiver 26 is adjacent first surface 22 of the substrate 20. Also, an adhesive agent 234 is placed between first surface 22 of substrate 20 and second surface 30 of first stain receiver 26. And adhesive 334 is placed agent between first surface 22 of substrate 20 and second surface 146 of second stain receiver 140.

The second stain receiver can contain either the liquid cleaning solution, the rinsing solution or nothing, but the second stain receiver preferably contains the rinsing solution. The second stain receiver is made of the same materials which can be used for the materials of the first stain receiver. The material for the second stain receiver is not necessary same as the material of the first stain receiver.

More preferably, the stain removal patch of the present invention further contain a liquid impermeable barrier around the second stain receiver. FIG. 8 is a schematic perspective view of another embodiment of a stain removal patch of the present invention. In FIG. 8, stain removal patch 621 comprises substrate 20, first stain receiver 26, second stain receiver 140 and a liquid impermeable barrier 36. As shown in FIG. 8, liquid impermeable barrier 36 covers second stain receiver edge 142 and extends over second stain receiver edge 142 to cover at least a portion of first surface 144 of second stain receiver 140.

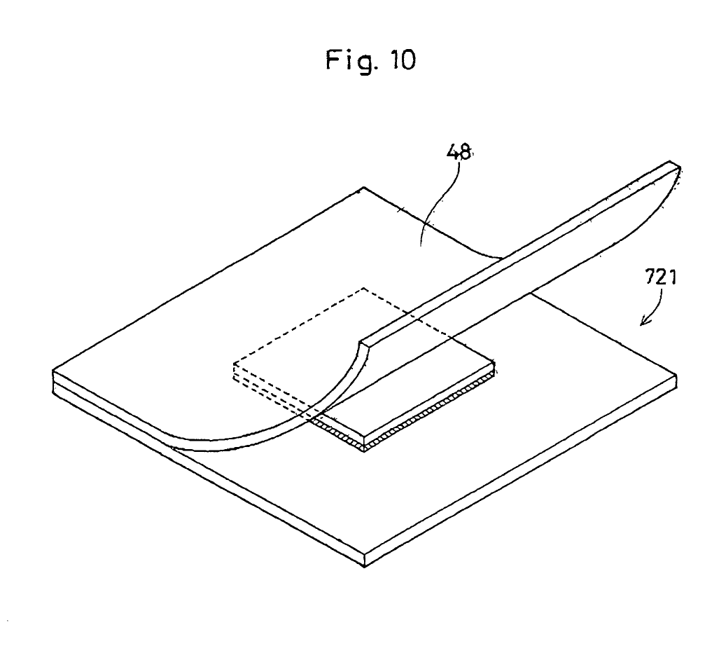

FIG. 9 shows a cross-sectional view of the stain removal patch in FIG. 8 as viewed along line 6-6. Second stain receiver 140 is wrapped by liquid permeable barrier 36 from second surface 146 to first surface 144. Space 137 is formed between second stain receiver edge 142 and liquid permeable barrier 36. Excess liquid cleaner is retained in space 137.

If there are more than two stain receiver, each stain receiver can contain either the liquid cleaner solution or the rinsing solution independently.

Normal spot stain removal products in the market sometimes leave ring-type stains after the use of these products. While not wanting to be limited by any theory, it is believed that ring-type stains are formed as follows. When adding liquid to stains, stains are solubilized in the liquid. The stain solubilized-liquid dissipates and the stains are away from the center of the starting position. Also residual cleaning solution often leaves on the surface. Consequently, ring-type stains are formed.

The present invention can reduce such stain ring-type stains as first stain receiver of the present invention absorbs stained solution. Second stain receiver of the present invention helps to prevent such ring-type stains. After applying the present invention to stained fabric, the liquid cleaner is loaded onto the stained fabric and the stains are penetrated. As a result, the stain is solubilized into the liquid cleaner. First stain receiver of the present invention absorbs the liquid cleaner containing stains and retain it to prevent ring-type stains from dissipating on the fabric again.

Second stain receiver absorbs such excess liquid cleaner. Accordingly, ring-type stains are not caused compared to other products.

The preferable thickness of the first and second stain receiver is less than 20 mm, preferably, from about 0.001 mm to about 3 mm, more preferably, from about 0.05 mm to about 1 mm of thickness.

Liquid Cleaner

The first stain receiver of the stain removal patch of the present invention contains a liquid cleaner. Preferably, the liquid cleaner is absorbed in the first stain receiver in advance. However, as described, it is possible to add liquid cleaners to the first stain receiver separately.

a) Surfactant

The liquid cleaner contains a surfactant which is selected from the group consisting of anionic, nonionic, cationic, zwitteric surfactants and a mixture thereof. Surfactants are known to the art, examples of such surfactants can be found in U.S. Pat. No. 5,756,444, issued May 26, 1998 to Scott et al., which is incorporated herein by reference.

Preferably, the surfactant is selected from the group consisting of a nonionic surfactant, an anionic surfactant and a mixture thereof. The liquid cleaner contains 0.1% or more, preferably from about 0.5% to about 30% by weight of a surfactant.

b) Solvent

The liquid cleaner also contains a solvent. Many types of known solvents can be used for solublizing the surfactant such as water, alcohol, organic solvent, ethanol amine etc. Preferable solvent is selected from the group consisting of water, an alcohol, an ethanol amine, a glycol ether and a mixture thereof. More preferably, the solvent is selected from the group consisting of water, benzylalcohol, monoethanol amine, propanediol, methoxy propoxy propanol, ethoxy propoxy propanol, butoxy propoxy propanol and mixtures thereof. Examples of such solvents can be found in U.S. Pat. No. 5,872,090, issued on Feb. 16, 1999 to Jing-Feng et al and PCT Patent application WO 9734519, published on Sep. 25, 1997 to Yeazell et al, which are incorporated herein by reference.

The liquid cleaner contains 5% or more, preferably, from about 50% to 95% by weight of a solvent.

c) Others

The liquid cleaner may further contain a chelating agent, a bleaching agent, an enzyme, and a malodor controlling agent.

The liquid cleaner may contain from about 0.01% to about 20% by weight of a chelating agent. The chelating agent is preferably selected from the group consisting of diethylenetriamine-N,N,N′,N″,N′″-penta acetic acid (DTPA), ethylenediamine tetra acetic acid (EDTA), polycarboxylate, ethylenediamine di succinate (EDDS) and mixtures thereof.

The liquid cleaner may further contain from about 0.01% to about 20% by weight of a bleaching agent. The bleaching agent is preferably selected from the group consisting of a hydrogen peroxide, a perborate, a percarbonate and a mixture thereof.

The liquid cleaner may further contain from about 0.001% to about 5% by weight of an enzyme. The enzyme is preferably selected from the group consisting of a protease, a lipase, an amylase, a cellulase and a mixture thereof.

The liquid cleaner may further contain from about 0.01% to about 10% by weight of a malodor control agent which is preferably selected from the group consisting of a cyclodextrin, a perfume, an antimicrobial agent and a mixture thereof.

Suitable ingredients including a bleaching agent, a chelating agent, a malodor controlling agent, an enzyme are disclosed and exemplified in U.S. Pat. No. 5,756,444, issued May 26, 1998 to Scott et al, in U.S. Pat. No. 5,478,503, issued Dec. 26, 1995 to Ronald. The entire disclosure of these references are incorporated herein by reference.

Rinsing Solution

The second stain receiver of the stain removal patch of the present invention may contain a rinsing solution instead of liquid cleaner.

The rinsing solution of the present invention is substantially free of surfactants. “Substantially free from surfactant” means that the rinsing solution contains less than 0.1% by weight, preferably less than 0.05%, more preferably, 0% by weight of a surfactant.

The rinsing solution contains solvents. Many types of known solvents can be used for the rinsing solution of the present invention such as water, alcohol, organic solvents etc. Preferable solvents are selected from the group consisting of water, alcohol, ethanol amine, mono ethanol amine and mixtures thereof. More than two stain receivers can be used in the present invention. At least one stain receiver must contain a liquid cleaner, but the remaining stain receivers may or may not contain a rinsing solution.

Cover Seal

The stain removal patch of the present invention may further contain a cover seal 48 as shown in FIG. 10. Stain removal patch 721 having cover seal 48 may prevent the liquid cleaner and the rinsing solution from leaking out of the stain receiver, particularly when consumer carry the stain removal patch. Also, the cover seal protect the adhesive agent when the patch is not in use. The material for the cover seal is preferably a water proof material in order to prevent leakage. More preferably, the materials are selected from the group consisting of polypropylene, polyethylene, polyethylene terephthalate (PET), rubbers and mixtures thereof. The cover seal can have multi-layers.

The cover seal can be coated with the adhesive agents which are used for coating with the substrate of the stain removal patch of the present invention. If coated, the adhesive preferably has a strength of less than 500 gf/25 mm, more preferably, from about 1 to about 100 gf/25 mm. This strength is measured to peel 25 mm wide adhesive on steel off as defined in Japanese Industrial Standard (JIS) test method (JIS Z 0237:1991) described in JIS handbook, Secchaku, 1992, published by Nihon Kikaku Kyokai.

Method for Removing a Spot Stain

The present invention also provides a method for removing a stain using the stain removal patch of the present invention.

The method comprises steps of: (a) applying the stain removal patch of the present invention to the stain; (b) leaving the stain removal patch on the stain for at least about 1 second, preferably, from about 3 seconds to about 15 minutes, more preferably, from about 5 seconds to about 5 minutes; and (c) removing the stain removal patch.

During the step (b), manual pressure or mechanical pressure can be applied over the substrate of the stain removal patch to urge the liquid cleaner into the stain.

The stain removal patch of the present invention can be applied to remove stains from soft surfaces such as clothes, shoes, carpets, sofas, car seats as well as hard surfaces such as walls, floors, kitchen tables and bath room fixtures.

The aspects and embodiments of the invention set forth in this document have many advantages, including easy carrying, improved spot stain removing performance, no leakage when the patch is not in use and prevention of ring-type stains.

The following examples further describe and demonstrate the preferred embodiments within the scope of the present invention. The examples are given solely for the purpose of illustration, and are not to be construed as limitations of the present invention since many variations thereof are possible without departing from its spirit and scope.

### EXAMPLES 1-6

Examples 1-6 show formula of the liquid cleaner of the present invention.

| | 1 (%) | 2 (%) | 3 (%) | 4 (%) | 5 (%) | 6 (%) |
|---|---|---|---|---|---|---|
| NI | 5 | 5 | 5 | 10 | 20 | 20 |
| AES | 0 | 5 | 5 | 5 | 5 | 5 |
| LAS | 5 | 5 | 5 | 5 | 5 | 5 |
| EDTA | 5 | 0 | 5 | 5 | 5 | 5 |
| DTPA | 0 | 5 | 0 | 0 | 0 | 0 |
| H2O2 | 5 | 0 | 0 | 5 | 0 | 5 |
| metal | 0 | 5 | 0 | 0 | 0.1 | 0.1 |
| catalyst | | | | | | |
| protease | 0 | 0.5 | 0.5 | 0.5 | 0.5 | 0.5 |
| lipase | 0 | 0 | 0.5 | 0 | 0.5 | 0 |
| amylase | 0 | 0 | 0 | 0.5 | 0.5 | 0 |
| beta- | 0 | 0.1 | 0 | 0 | 0 | 0.1 |
| cyclodextrin | | | | | | |
| perfume | 0.1 | 0.1 | 0 | 0 | 0 | 0.1 |
| benzylalcol | 0 | 0 | 5 | 5 | 5 | 5 |
| water | up to | up to | up to | up to | up to | up to |
| | 100 | 100 | 100 | 100 | 100 | 100 |

NI: nonionic surfactant
AES: Alkyl Ehoxylated sulphonate
LAS: Linear alkylbenzene sulphonate
EDTA: Ethylenediamine tetra acetic acid
DTPA: diethylenetriamine-N,N,N′,N77,N777-penta acetic acid

### EXAMPLES 7-11

Examples 7-11 show formula of the rinsing solution of the present invention.

| | 7 (%) | 8 (%) | 9 (%) | 10 (%) | 11 (%) |
|---|---|---|---|---|---|
| MeOH | 0 | 5 | 0 | 0 | 0 |
| EtOH | 0 | 0 | 5 | 20 | 5 |
| NI | 0 | 0 | 0 | 0 | 0.01 |
| perfume | 0 | 0 | 0 | 0.1 | 0 |
| water | 100 | 95 | 95 | 79.9 | 94.95 |

MeOH: methanol
EtOH: ethanol
NI: nonionic surfactant

It is understood that the examples and embodiments described herein are for illustrative purposes only and that various modifications or changes in light thereof will be suggested to one skilled in the art and are to be included in the spirit and purview of this application and scope of the appended claims.

What is claimed is:

1. A stain removal patch comprising:
(a) a substrate having a first and second surface;
(b) a first stain receiver having a first and second surface and an edge that defines a stain receiver perimeter, the first stain receiver comprising a liquid cleaner absorbed therein, wherein the second surface of the first stain receiver is adjacent the first surface of the substrate;
(c) where at least a portion of the first surface of the substrate extends beyond the perimeter of the first stain receiver; and
(d) an adhesive agent between the first surface of the substrate and the second surface of the first stain receiver wherein at least a portion of the adhesive agent on the first surface of the substrate extends beyond the perimeter of the first stain receiver.

2. The stain removal patch according to claim 1, further comprising a cover seal.

3. The stain removal patch according to claim 1, wherein the first stain receiver is selected from the group consisting of a polymerizing high internal phase water-in-oil emulsion, a non-woven fiber, a woven fiber, a polyurethene foam and mixtures thereof.

4. The stain removal patch according to claim 1, wherein the liquid cleaner comprises 0.1% or more by weight of a surfactant.

5. The stain removal patch according to claim 4, wherein the liquid cleaner further comprises a malodor control agent.

6. The stain removal patch according to claim 4, wherein the liquid cleaner comprises an enzyme.

7. The stain removal patch according to claim 1, wherein the first stain receiver has a liquid impermeable barrier that covers the first stain receiver edge and extends over the first stain receiver surface to cover at least a portion of the first surface of the first stain receiver forming a window that exposes a portion of the first surface of the first stain receiver.

8. The stain removal patch according to claim 7, wherein the area of the window is from about 50% to about 99.9% of the surface area of the stain receiver.

9. The stain removal patch according to claim 1, wherein the stain removal patch further comprises a second stain receiver having an edge that defines a second stain receiver perimeter, and the second stain receiver comprises a rinsing solution.

10. The stain removal patch according to claim 9, wherein the second stain receiver is sandwiched between the first stain receiver and the substrate, and wherein at least a portion of the substrate extends beyond the perimeter of at least a portion of the second stain receiver and the second stain receiver extends beyond the perimeter of the first stain receiver.

11. The stain removal patch according to claim 9, wherein the second stain receiver is adjacent the perimeter of the first stain receiver.

12. A method for removing a stain comprising the steps of:
(a) applying the stain removal patch according to claim 1 to the stain;
(b) leaving the stain removal patch on the stain for at least about 1 second; and
(c) removing the stain removal patch.
